(19) United States
(12) Patent Application Publication
(10) Pub. No.: US 2009/0172140 A1
(43) Pub. Date: Jul. 2, 2009

(54) NETWORK DEVICE

(76) Inventor: Richard John Pilkington, Newtown (GB)

Correspondence Address: HARNESS, DICKEY & PIERCE, P.L.C., P.O. BOX 828, BLOOMFIELD HILLS, MI, 48303, US

(21) Appl. No.: 11/965,305

(22) Filed: Dec. 27, 2007

(51) Int. Cl. G06F 15/173

(52) U.S. Cl. 709/223

(57) ABSTRACT

A Network Attached Storage Device (NAS) that is configured to receive at least one webfeed and display information derived from the webfeed on a display.

### BACKGROUND OF THE INVENTION

(1) Field of the Invention

The present invention relates to devices that may be connected to a computer network, for example a computer network that may be provided in a home or in an office.

(2) Description of Related Art

Such networks may be connected to the Internet, enabling users of the network to acquire information that is available from the Internet. A recent development for Internet users has been the provision of webfeeds. A webfeed may be used to provide information that is frequently updated. A user may subscribe to a webfeed, obtaining new content as it is provided. Accordingly, a user need not repeatedly visit a particular website in order to monitor for new content.

Webfeeds may be particularly useful for frequently updated information, such as news, financial information, traffic reports and weather reports. However, although the provision of webfeeds makes it easier for a user to quickly obtain updated information without the need to visit one or more websites and inspect it for the updated information, it is still necessary for the user to use their computer in order to obtain that information from the Internet. Accordingly, the user may be inconvenienced, for example if their computer is switched off and they must turn it on in order to obtain the information, if another person is using the computer and/or the computer is being used for a different task.

Therefore, it would be desirable to provide an easier system for a user to obtain information.

### BRIEF SUMMARY OF THE INVENTION

According to the present invention there is provided a computer network device, comprising:

a Network Attached Storage device (NAS), configured to be connected to a network, and

a display;

wherein the Network Attached Storage device (NAS) is configured to receive at least one webfeed and display information derived from said at least one webfeed on said display.

Accordingly, the information available from an Internet webfeed is readily available to a user without the need for the user to access a computer.

This may be beneficial in particular if the Network Attached Storage device (NAS) is configured to be switched on at all times. This will typically be the case so that all users of the network can access data stored within the Network Attached Storage device at any time. Accordingly, because the Network Attached Storage device is already on, as soon a user wishes to view the information from a webfeed, they may simply look at the device display and need not wait while it is initialised, as would the case if they were to view the data using their computer.

In general, a Network Attached Storage device (NAS) is a device that is configured to provide data storage for the network users. However, Network Attached Storage devices generally are configured such that they cannot perform other functions, namely run other applications. Accordingly, it will be appreciated that a network device according to the present invention may be arranged such that the only functions that it performs are the function of storing data for network users and displaying information from webfeeds on the display.

In order to perform the storage function, the Network Attached Storage device (NAS) may include a memory that is configured to store the data. The present invention is not limited to any particular form of memory. Accordingly, it may, for example, be provided by one or more hard disks, which may be arranged in any convenient configuration, a solid state memory and/or a memory based on recordable CDs or DVDs. It will be appreciated that the Network Attached Storage (NAS) device will be configured to enable users to access the data that is stored in the memory.

The Network Attached Storage device (NAS) may be configured via the network to which it is attached. For example, a user may configure the Network Attached Storage device (NAS) by accessing the Network Attached Storage device (NAS) on a computer that is also connected to the network. As will be appreciated, in order to minimise costs and facilitate manufacturing of the Network Attached Storage device (NAS), it may be kept as simple as possible. Accordingly, because the Network Attached Storage device may be configured remotely, a full keyboard may not be necessary for the Network Attached Storage device. Accordingly, the Network Attached Storage device (NAS) may not be provided with a full keyboard, such as a QWERTY keyboard and/or may not be provided with the ability to connect a full keyboard to the Network Attached Storage device.

In addition to configuring the Network Attached Storage device (NAS) remotely, the display of information derived from the one or more webfeeds on the display of the network device may also be configured remotely. For example, the user may select which webfeeds and/or which portions of which webfeeds are displayed, the layout of the display and/or any other feature of the display by accessing the network device on a computer that is also connected to the network.

The Network Attached Storage device (NAS) may include an aggregator that obtains the information from the webfeeds. It will be appreciated that this may be a software application that is run on the operating system of the Network Attached Storage device (NAS). Such an aggregator may be configured to keep a record of the webfeeds to which it is subscribed and then check for new content periodically and retrieve the updates. The most up-to-date information may then be displayed on the display. It will be appreciated that, when a user configures the Network Attached Storage device (NAS), the user may select the webfeeds to which the aggregator is subscribed and/or may select the frequency with which the aggregator checks for new content.

Alternatively or additionally, the Network Attached Storage (NAS) may be arranged such that it obtains information from a web based aggregator. Such an aggregator performs a similar function as the aggregators discussed above, and are also user-configurable in the same manner, but are provided on a web page accessible via the Internet.

An aggregator used for the current invention may be configured such that it can receive webfeeds having one or more different formats, such as the RSS format and/or the Atom format.

Although the Network Attached Storage device (NAS) may be such that it can be remotely configured or may only be remotely configured, it may be desirable to enable the user to switch between information from different webfeeds whilst viewing the display on the Network Attached Storage device (NAS) without requiring the user to use another device connected to the network. Accordingly, the Network Attached Storage device may include some form of user interface that enables the user to change which information is displayed. For example, the Network Attached Storage device (NAS) may be configured to obtain information from a plurality of webfeeds but only to display information from one webfeed at a time. Accordingly, the user may select a particular webfeed using the user interface and the information derived from that webfeed may be displayed on the display. It should be appreciated, however, that the Network Attached Storage device (NAS) may be configured such that information from two or more webfeeds may be simultaneously displayed on the display. Accordingly, the user interface may be used to select the combination of webfeeds to be displayed on the display.

In a particular arrangement, the user interface may have a plurality of buttons or switches or other input means and the user may be able to configure the Network Attached Storage device (NAS) such that each button, switch or other input means is associated with a single webfeed or single combination of webfeeds and, when the user presses the button, switch or other input means, the information derived from the associated one or more webfeeds is displayed on the display.

In an alternative arrangement, the Network Attached Storage device (NAS) may only include a single button, switch or other input means for selecting the information on the display and it may be configured such that, as the user repeatedly presses the button, switch or other input means, the information shown on the display switches between the different webfeeds or combinations of webfeeds that the Network Attached Storage device (NAS) is configured to display.

It should be appreciated that the display of the network device may be any convenient display means suitable for displaying the information derived from the webfeed. For example, the display may be an LCD. It should also be appreciated that the display may be limited to text information derived from the webfeeds and/or may include images for display and/or video images.

A network device according to the present invention may be used in conjunction with a variety of different networks (although it should be appreciated that a particular network device may only be configured to work with a single type of network) and it is not intended for the present application to be limited to a particular kind of network. Likewise, a network device according to the present invention may be connected to the network by a plurality of different means and it is not intended for the present application to be limited to a particular type of connection. In particular, a computer network device according to the present invention may be configured to be able to connect to a network by, for example, one or more of a wireless connection, an Ethernet connection and/or an IEEE 1394 connection. Similarly, it will be appreciated that a computer network device according to the present invention may be configured to be connected to an IP (Internet Protocol) network. Accordingly, the network may be directly connected to the internet, enabling the Network Attached Storage device (NAS) to obtain the webfeed information from the internet directly via the network. Alternatively, or additionally, a computer network device according to the present invention may be configured to connect to a non-IP network. In such an arrangement, the network may include a bridge that enables it to connect to the network and through which the Network Attached Storage device (NAS) may receive the webfeed information.

The present invention will now be described by way of non-limiting examples, with reference to the accompanying drawings.

### BRIEF DESCRIPTION OF THE DRAWINGS

FIG. 1 depicts an embodiment of a computer network device according to the present invention;

FIG. 2 depicts an alternative configuration of a computer network device according to the present invention;

FIG. 3 depicts an arrangement of a computer network device according to the present invention within a network; and

FIG. 4 depicts an arrangement of a computer network device according to the present invention arranged within an alternative network.

### DETAILED DESCRIPTION OF THE INVENTION

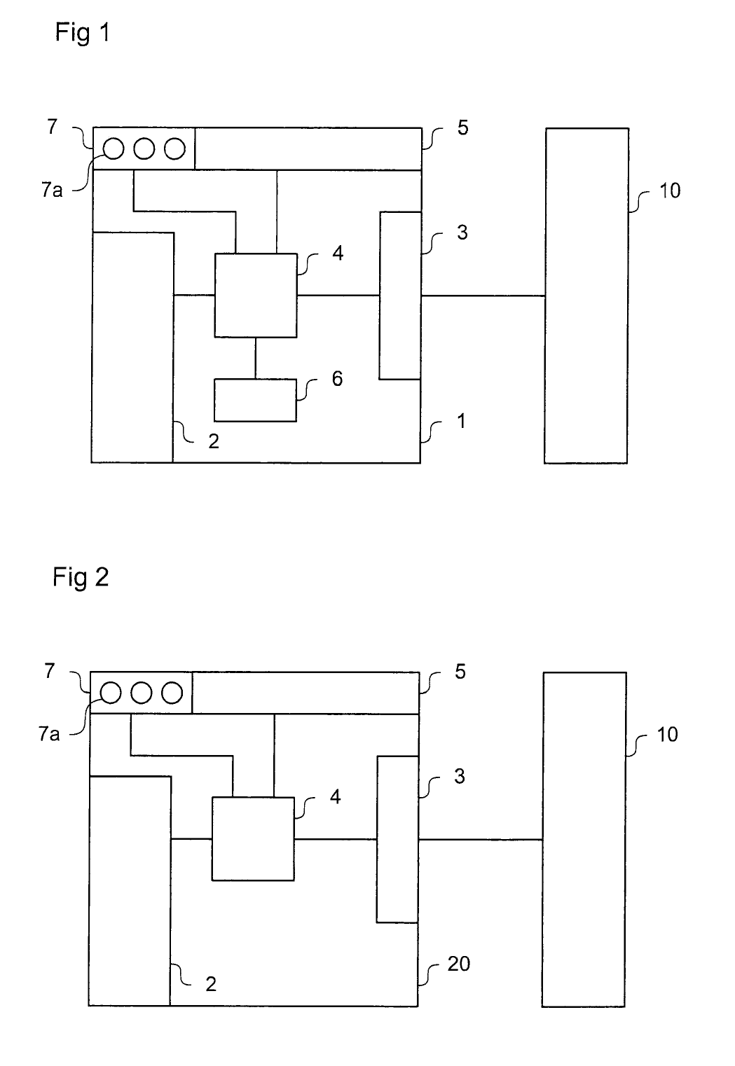

As depicted schematically in FIG. 1, a computer network device of the present invention 1 may include a memory 2 for storing data in a manner conventional to Network Attached Storage device (NAS). The computer network device 1 further includes a network interface 3 by which the device may communicate with a network 10 and a controller 4 for controlling the computer network device. In addition, a display 5 is provided for displaying information derived from a webfeed. An aggregator 6 is provided which is configured to periodically check for new content and retrieve updated content from the webfeeds for display.

It should be appreciated that the computer network device is in general configured in the same manner as a conventional Network Attached Storage device (NAS) but is additionally provided with the display 5 and the aggregator 6. It should further be appreciated that the aggregator 6 may, as schematically depicted in FIG. 1, be a separate unit from the controller 4 but also may, instead, be implemented within the controller 4. In particular, the aggregator 6 may be implemented by means of a computer program within the controller 4 of the computer network device 1.

The memory 2 may be any convenient form of memory, including but not limited to, a hard disk, an array of hard disks, a solid state memory, a recordable CD, a recordable DVD and/or any combination thereof. The computer network device is configured such that when it is connected to the network 10, users on the network 10 may store data to the memory 2 of the computer network device and/or retrieve data from the memory 2. In general, the computer network device 1 will be configured such that, by storing and retrieving data from the memory 2, users on the network may share data.

The display 5 may, for example, be an LCD. However, it should be appreciated that any convenient display may be used. Depending on the type of display used, the display may be configured solely to display text information, which may simplify the nature of the display and/or the control of the display 5. Alternatively, the display 5 may be such that it can display images and/or video images if these are available from the webfeeds.

The aggregator 6 may, for simplicity, be configured to subscribe to a single webfeed and to periodically check for updated content from that webfeed. However, in order to improve the functionality provided to the user, the aggregator 6 may be configured to subscribe to a plurality of webfeeds.

The aggregator 6 may be configured remotely by a user, for example by using a computer connected to the network 10. Accordingly, the user may select the webfeeds to which the aggregator 6 is subscribed. In addition, the user may also be able to configure the aggregator 6 or controller 4 in order to select the information from a particular webfeed to which the aggregator 6 is subscribed that is to be displayed on the display 5. For example, if the aggregator 6 is subscribed to a webfeed providing traffic news, the computer network device 1 may be configured such that only traffic news relating to a particular geographic area is displayed on the display 5. It will be appreciated that the means for configuring the aggregator 6 remotely may be the same means as may be used to configure the storage functions of the computer network device, namely the function of the Network Attached Storage device (NAS). Alternatively or additionally, the aggregator may be pre-configured, for example in the factory, to display one or more predetermined webfeeds.

The computer network device 1 schematically represented in FIG. 1 also includes a user interface 7 that may be used to select information to be displayed on the display 5. For example, a user may configure the computer network device to have a plurality of viewing modes, each associated with a display of information from one or more webfeeds. The user interface 7 may have a button 7a or switch associated with each viewing mode such that, when the user activates a button or switch the display 5 shows the corresponding mode.

It should be appreciated that any input means may be provided and may include, for example, a portion of a touch-screen device incorporated within the display 5.

It should further be appreciated that, instead of providing a button, switch, or other input means associated with each viewing mode, a single input means may be provided and the computer network device 1 may be configured such that each time the button, switch or input means is activated the display 5 changes to a different mode. In particular, for example, repeated activation of the button, switch or other input means may result in the display 5 cycling between the different modes.

As explained above, each mode may be configured to display information derived from one or more webfeeds. For example, in a simple case, each webfeed may provide the information for a single viewing mode. Alternatively, information from two or more webfeeds may be combined for a single mode. Furthermore, different modes may be used to select different information from common webfeeds. Referring to the example provided above, if a webfeed provides traffic information, one viewing mode may be configured to provide traffic information relating to a first geographical area and a second mode may be configured to provide traffic information relating to a second geographic area.

FIG. 2 schematically represents a computer network device 20 that is a variation of the computer network device depicted in FIG. 1. The parts of the computer network device 20 depicted in FIG. 2 that are the same as those of the computer network device 1 depicted in FIG. 1, have the same reference numerals and, for brevity, the description thereof will not be repeated. It should also be understood that the variations discussed above in relation to FIG. 1 may also apply to the computer network device 20 depicted in FIG. 2.

The primary difference of the computer network device 20 depicted in FIG. 2 is that it does not in itself include an aggregator. Instead, the computer network device 20 is configured to receive the webfeed information from a web-based aggregator, namely a web page that is configured to perform the function of an aggregator. It should be appreciated that the computer network device 20 may receive all of the information from the web-aggregator and may be subsequently configured to display a selected portion of that information on the display 5. Alternatively, a user may configure the web-based aggregator or the computer network device 20 such that only a selected portion of the information obtained by the web-aggregator is transferred to the computer network device 20. Accordingly, the data transfer across the network 10 may be minimised.

The computer network device of the present invention may be configured to operate with any desired network and, accordingly, may be connected to the network 10 in any appropriate fashion. For example, it may be wirelessly connected to the network 10, may be connected by an Ethernet connection and/or may be connected to a network 10 by means of an IEEE 1394 connection.

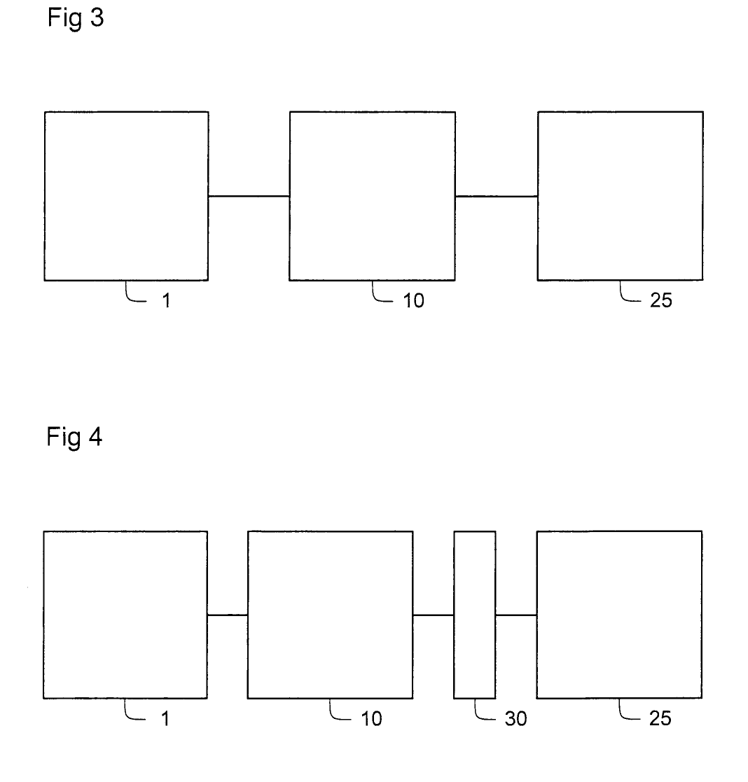

It will be appreciated that, where the network is an IP (Internet Protocol) network, it may be directly connected to the internet 25 as schematically depicted in FIG. 3. In this case, the computer network device 1 is easily connected through the network 10 to the internet 25 to receive the webfeed information.

However, if the network 10 is not an IP network, the webfeed information may still be obtained from the internet 25 but, as depicted in FIG. 4, it may be necessary to provide a bridge 30 between the internet 25 and the network 10 in order to convert the webfeed data into a protocol by which the data may be transferred over the network 10 to the computer network device 1.

In any case, the webfeed data may initially be provided in any conventional format for webfeed data, such as, for example, RSS or Atom.

1. A computer network device, comprising:
a Network Attached Storage device (NAS), configured to be connected to a network, and
a display;
wherein the Network Attached Storage device (NAS) is configured to receive at least one webfeed and display information derived from said at least one webfeed on said display.

2. A computer network device according to claim 1, wherein the Network Attached Storage device (NAS) comprises an aggregator that is configured to acquire said at least one webfeed from the internet.

3. A computer network device according to claim 1, wherein the Network Attached Storage device (NAS) is configured to receive said at least one webfeed from a web based aggregator.

4. A computer network device according to claim 1, further comprising a user interface for receiving a user command;
wherein the Network Attached Storage device (NAS) is configured to change the display of information derived from said at least one webfeed on said display in response to a user command received by said user interface.

5. A computer network device according to claim 4, wherein said user interface comprises a plurality of user-activated inputs; and the Network Attached Storage device (NAS) is configured such that, when each user-activated input is activated, it displays information derived from one or more webfeed associated with said activated user-activated input.

6. A computer network device according to claim 4, wherein said user interface comprises a single user-activated input; and the Network Attached Storage device (NAS) is configured to display one of a plurality of views on said display, each view containing information derived from at least one webfeed; and the Network Attached Storage device (NAS) is configured to switch to a different view when said user-activated input is activated.

7. A computer network device according to claim 1, wherein the Network Attached Storage device (NAS) may only be configured via a network to which it is attached.

8. A computer network device according to claim 1, wherein the display of information derived from said at least one webfeed on said display may be configured via a network to which it is attached.

9. A computer network device according to claim 1, wherein the Network Attached Storage device (NAS) is configured to remain on permanently

10. A computer network device according to claim 1, wherein the Network Attached Storage device (NAS) does not include a full keyboard and is not configured such that a full keyboard maybe directly connected to the Network Attached Storage device (NAS) in order to control the Network Attached Storage device (NAS).

11. A computer network device according to claim 1, wherein the Network Attached Storage device (NAS) is configured to perform solely the functions of providing network storage and displaying said information derived from said at least one webfeed.

12. A computer network device according to claim 1, wherein the Network Attached Storage device (NAS) comprises a memory; and the Network Attached Storage device (NAS) is configured to store data from devices connected to a network to which the Network Attached Storage device (NAS) is connected.

13. A computer network device according to claim 1, wherein the Network Attached Storage device (NAS) is configured to receive webfeeds in at least one of the RSS format, the Atom format and other standard webfeed formats

14. A computer network device according to claim 1, wherein the Network Attached Storage device (NAS) is configured to be wirelessly connected to a network.

15. A computer network device according to claim 1, wherein the Network Attached Storage device (NAS) is configured to connect to a network by an Ethernet connection.

16. A computer network device according to claim 1, wherein the Network Attached Storage device (NAS) is configured to connect to a network by an IEEE 1394 connection.

17. A computer network device according to claim 1, wherein the Network Attached Storage device (NAS) is configured to be connected to an IP network that is connected to the internet.

18. A computer network device according to claim 1, wherein the Network Attached Storage device (NAS) is configured to be connected to a non-IP network; and the Network Attached Storage device (NAS) is configured to receive said at least one webfeed from a network bridge that connects the non-IP network to the internet
19. A non-IP computer network, comprising a computer network device according to claim 18 and a network bridge;
wherein the network bridge is configured to connect the non-IP network to the internet.
